(19) United States
(12) Patent Application Publication
(10) Pub. No.: US 2015/0160030 A1
(43) Pub. Date: Jun. 11, 2015

(54) Method for identifying scenic routes

(71) Applicant: con william costello, naas (IE)

(72) Inventor: con william costello, naas (IE)

(21) Appl. No.: 14/555,606

(22) Filed: Nov. 27, 2014

(30) Foreign Application Priority Data
Nov. 29, 2013 (GB) GB1321107.3

(51) Int. Cl. G01C 21/34

(52) U.S. Cl. CPC G01C 21/3476

(57) ABSTRACT

A method for the identification of scenic routes and production of navigation data, comprising; a road network model, digital elevation model, view-shed visibility polygons, environmental and temporal data.

Sample points are created throughout the survey area and visibility view-sheds created at each sample point. A novel method for checking the accuracy of view-sheds is disclosed.

Environmental data is attributed to each sample point to describe the scenery visible at each location, including; scale of view, land-cover, population density, crop type, regional affluence, recommended views, heritage areas, road windingness or undulation, points-of-interest, parklands, established or themed routes, routes of genealogical interest, etc.

A method for the recording of temporal attributes is also disclosed, providing for the dynamic calculation of scenic index where scenery changes over time, including; night views, sunsets, flowering vegetation, autumnal trees or the northern lights.

### FIELD OF INVENTION

This invention relates to vehicles, specifically to an improved navigation system and a method for the identification of scenic routes.

### BACKGROUND

Satellite navigation devices are increasingly popular and used daily by millions of people across the world. Typically employing GPS, software and a road network model, these devices permit the user to determine the ‘shortest’ or ‘fastest’ route to a destination.

Motorists however are not only interested in the fastest or shortest route; ‘scenic’ routes are also of importance. For example, a traveller may wish to travel the slow road between sights, to follow a loop route returning to their hotel or to simply wander with no particular destination in mind.

Scenic routing is already available, though limited in terms of quality as existing navigation devices lack sufficient data to enable a reliable comparison of routes in terms of scenic appeal. The invention disclosed provides a novel method for the preparation of data which quantifies scenic appeal and may be used within a navigation application.

Navigation applications typically require two primary forms of input data. a) geographic data which describes the road network in geographic terms, illustrating how each road segment is connected to it's neighbour, and b) attribute data which records the characteristics of each road segment. The two data sets, collectively known as the ‘road network model’, may be stored in a number of machine readable formats where they may be interrogated by the navigation application software.

The creation of attribute data quantifying scenic value is challenging. ‘Scenery’ is a subjective concept which varies with individual taste and background, it can be difficult to align surveyor' and user expectations. Scenic qualities also change over time, for example; an urban skyline may be scenic at night but disappointing during the day, a forest route may only be impressive during Autumn, or a seascape at sunset.

The invention disclosed identifies features which are universally considered scenic, and isolates those which may be considered subjective in order to permit a user to express a preference within a navigation application. It provides for the compilation of many attributes which may define scenic character, and for the creation of a ‘scenic index’ value which may be used within a navigation application.

### SUMMARY OF THE INVENTION

A requirement therefore exists for a method to survey roads in terms of scenic content, leading to the production of attribute data suited to ‘scenic’ navigation.

The object of the present invention is solved by the subject-matter of the independent claims, wherein further embodiments are incorporated in the dependent claims. It should be noted that the following described aspects of the invention apply also for the method, the system and the vehicle.

According to the invention, a method is provided for the identification of scenic routes comprising the steps of a) Identifying sample locations along a road network, b) Attributing said sample locations with at least one value.

Attribute data is preferably universal, consistent, and without bias; enabling comparative reference throughout. Preferably, it will assess the visual environment in detail, identifying and quantifying features which are commonly known to be of scenic value, and ideally contain sufficient content so as to accommodate individual user preferences and consideration of temporal constraints within a navigation application.

The invention disclosed provides a process for the production of such data. It offers a novel method for the desktop survey of each individual route in terms of visual, environmental, cultural, temporal and social context and offers a practical method for the creation of the attribute data required for scenic navigation.

The method outlined describes the potential use of a road network model in order to identify appropriate sample points along routes, use of a digital elevation model (DEM) to create visibility ‘view-sheds’ at each sample point, and the union of layers of geographically referenced environmental data in order to populate the attribute database—in so doing creating a rich record of the type, scale and quality of scenery at each point. The process required to perform these steps will be understood by a person skilled in the art.

Attribute data describing scenic value provides for a number of novel navigation functions beyond those currently available. For example; Point to point routes: where a preferred destination is selected and the navigation system provides the user with the most scenic route between origin and destination. Loop routes: where the journey origin and destination are coincident, and through input of a preferred tour distance, duration, and/or theme, the user is guided through the most attractive scenery. Tours of indefinite duration: where the journey has no defined destination and the motorist is perpetually navigated through the most attractive local routes. Or routes of defined deviation: where the motorist specifies a permitted scenic deviation, in terms of time or distance, from the shortest or fastest route.

It should not be considered that this method is restricted to use within road, rail, air or water navigation applications. The methodology disclosed herein pertains to the broad subject of scenic value determination and may be employed across a number of additional fields, including development planning or tourism, or consumer applications.

It is an aspect of the invention to provide a method for the production of data which may be used within a navigation system to perform scenic routing.

Accordingly, there is provided a method as described above, and a system comprising: a means to identify sample point locations; a means to create survey areas associated with said sample points, wherein the sample points are attributed with at least one value representing scenic content.

The method and the system are advantageous in that they provide a flexible methodology for the universal assessment of scenic value.

In one embodiment, the method includes a road network model, and a means for identifying sample points along said road network model either irregularly or at a preferred interval.

In one embodiment, the method employs a digital elevation model (DEM) and a means for the computation of a view-shed polygon from each individual sample point.

In another embodiment, the method includes calculation of sky-view-factor (SVF) in order to improve the correctness of view-shed polygon creation.

In one embodiment, the method includes terrestrial imagery in order to improve the correctness of view-shed computation.

In a further embodiment, the method includes the splitting of said view-shed polygon either radially, concentrically, or otherwise, and the attribution of individual portions.

In one embodiment, the method includes the simplification of the geometry of said view-shed polygon through the removal of redundant nodes.

In another embodiment, the method includes the calculation of view-shed polygon dimensions and the recording of such dimensions within the attribute table.

In one embodiment, the method includes the computation of land-cover within each view-shed polygon, for example the predominant cover within the viewshed.

In a further embodiment, the method includes the calculation of population density and/or number of households within each view-shed polygon in order to provide an attribute approximating the visible urban density.

In one embodiment, the method includes the calculation of recommended and/or protected views within each view-shed polygon in order to access the percentage of the view known to be considered scenic.

In another embodiment, the method includes the calculation of established and/or themed tourist routes at each sample point.

In another embodiment, the method includes the calculation of tourist features, for example; heritage buildings or villages, points of interest and/or national monuments, within each view-shed polygon.

In one embodiment, the method includes the calculation of relative deprivation and/or affluence within each view-shed polygon.

In one embodiment, the method includes the calculation of route windingness and/or undulation at each sample point. This will typically be recorded as a single value indicating the character of the road at that point.

In one embodiment, the method includes the calculation of the ultimate coastal route, wherein the route is attributed with a value indicating it is the route closest to the sea.

In another embodiment, the method includes the attribution of road classification and/or typical speed at each sample point.

In one embodiment, the method includes the calculation of conservation areas and/or parklands within each view-shed polygon and the quantification of such areas within the attribute table.

In one embodiment, the method includes the calculation of areas of genealogical interest at each sample point, wherein regionally common family names may be attributed to survey points.

In one embodiment the method includes the use of social network applications to identify popular scenic views and the linking of such recommendations to nearby survey point.

In one embodiment, the method includes the calculation of temporal scenic data within each view-shed polygon, such as a particular scenic event and the dates associated with it's occurrence.

In one embodiment the method includes a facility to record view-shed boundaries within the attribute database in order to facilitate the dynamic creation of scenic attributes.

In one embodiment, the method includes the calculation of solar and lunar positions.

In one embodiment, the method includes the calculation of risk at each sample point.

In one embodiment, the aforementioned environmental data found within each view-shed polygon is summarised by user preference and qualitative and/or quantitve values attributed to each corresponding sample point.

In another embodiment scenic attribute data may be used in the creation of semi-transparent ‘clouds’ which may be over/under laid upon a map in order to infer a predominant scenic theme.

In yet another embodiment, the view-shed polygon may be substituted with concentric ring polygons, and/or any alternate selection mechanism.

These and other aspects of the present invention will become apparent from and be elucidated with reference to the embodiments described hereinafter.

### BRIEF DESCRIPTION OF THE DRAWINGS

The invention may be more clearly understood from the following description of a preferred embodiment thereof which is given by way of example only with reference to the accompanying drawings, in which:

FIG. 1 shows a top view of a road network model with sample points; and

FIG. 2 shows a top view of a road network model with view-shed polygon overlaid; and

FIG. 3 shows a top view of a road; and

FIG. 4 shows a ground-up view of the visible sky, and

FIG. 5 shows a side view of a view-shed

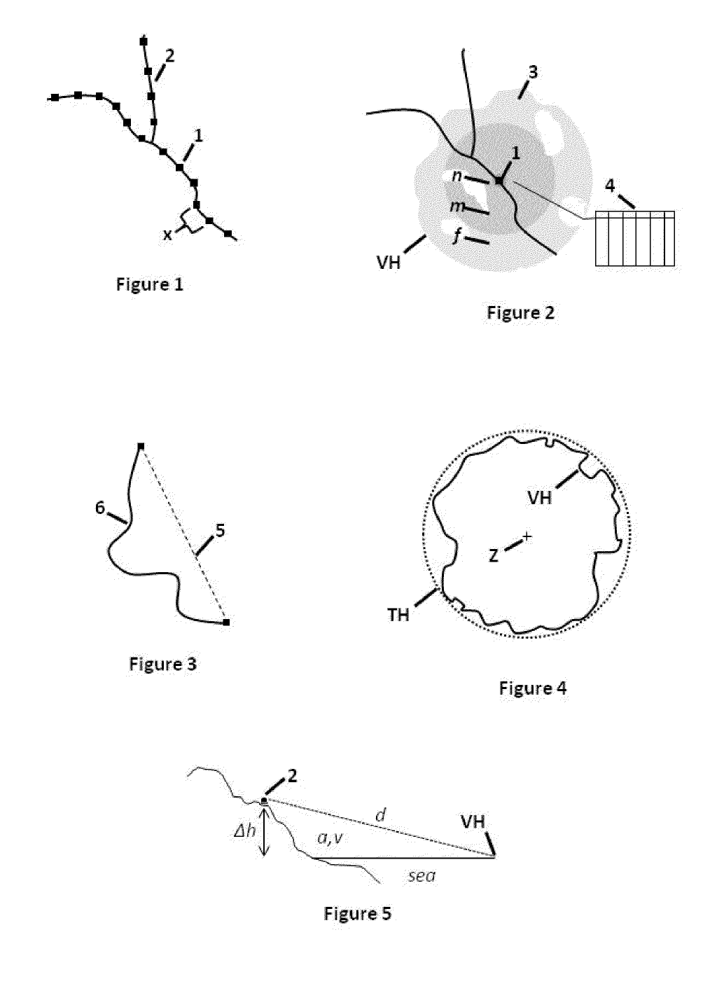

### DETAILED DESCRIPTION OF THE DRAWINGS

According to the invention, as shown in the figures, there is provided a method for the creation of attribute data (4) which quantifies the scenic value (attractiveness) of roads for the purpose of utilisation within a navigation system.

Said method comprises a means to identify sample points (1) along a road network (2); a means to create survey areas associated with said sample points, wherein the sample points are attributed with at least one value representing the scenic content within each polygon.

The production of the attribute data may be considered as a four step process:

Step A. Identification of Sample Locations

It is preferable to identify sample point locations (1) throughout the region of interest. Such locations are most easily identified through the creation of points along an existing road network model (2), though they may be identified in any way and located at any geographic location.

It is preferable that sample points are at regular intervals; though irregularly spaced and/or supplementary points are beneficial under certain circumstances, such as complex geographies. The interval between sample points (x) is sufficiently short as to represent the character of the road; this is typically in the order of 1-200 m, though may vary substantially depending upon local topography, the level of accuracy demanded and/or the computer processing power available.

Then, sample points (1) are ideally each attributed with a unique identifier. It is also advantageous to attribute the points with the unique identifier of their parent road segment, though this is optional, or may be done later if preferred.

Step B. Identification of Survey Areas

Survey areas surrounding each sample point are produced. Ideally, these should be graphical ‘view-shed polygon’ areas (3) as these better represent the visual experience at each location, though survey areas may simply be circular in shape, or any form suited to spatial selection.

The creation of view-shed polygons (3) is performed using a point-to-multipoint or similar inter-visibility technique utilising an appropriate digital elevation model (DEM). While any DEM may be used, it should ideally be ‘canopy’ in type rather than ‘bald earth’ and of as high a resolution as possible, as this will yield the best result. Ideally, the view-shed calculation used will consider earth curvature and optical refraction, and therefore represent the visible horizon (VH) of each sample point (1).

It is preferable to test the view-shed calculation for accuracy. This may be done by field truth survey, or comparison with terrestrial photographs and/or video captured in the field. One procedure for comparative testing is the ‘sky-view-factor method’; this involves forming a comparison between the predicted area of sky visible according to the view-shed computation, and the measured area of sky visible at the corresponding point on the road. The sky-view-factor method demands reversal of the view-shed calculation in order to determine the predicted area of sky visible; and the field survey of sky-view-factor though use of a camera equipped with a fish-eye lens. Sky view factor is typically represented as a figure between 0 and 1, wherein 0 means that no sky is visible and 1 means that the full true horizon (TH) is visible, though it may be quantified in any way. The concept of sky view may be more easily understood by reference to FIG. 4 wherein the zenith (Z), true horizon (TH) and visible horizon (VH) are indicated.

Accordingly, a view-shed polygon (3), a shape defining the visible area, is created for each sample point (1). Polygon's are optionally ‘thinned’, or otherwise simplified using standard methods, in order to conserve storage space and/or reduce processing workload at later stages.

Optionally, view-shed polygons are also split in order to divide the view into logical portions; for example, split along the direction of the highway in order to represent what may be viewed to left and right, and/or split into concentric zones, for example; representing the near (n), middle (m), and/or far (f) fields of view.

Step C. Union of Environmental Data

View-shed polygons (3) are overlaid with each layer of environmental data and their associated sample points (1) are attributed with data summarising the content of each view-shed (3).

Environmental data may be defined as any data describing the natural, built or social environment, and is typically stored in an attribute database (4). Summarisation may take many forms, varying with data type or preference; attributes are typically either quantitve or qualitative in nature, for example; representing the percentage of the view-shed covered by a particular land cover class, or totalling the number of points of interest within view, etc.

In one embodiment, wherein the view-shed polygon has been split, sample point attributes may represent different portions of the view-shed (3). For example; the near (n), middle (m), far (f), left or right fields of view; or the immediate vicinity of a sample point. This approach ensures that features which are only of scenic value at a certain range are appropriately represented. Where this approach has been employed, additional data fields are added in order to store the additional attribute data, but otherwise the process continues as described.

Detailed description of the attribution process.

The process of attribution of survey points is by spatial intersection, a technique which will be understood by a person skilled in the art. Various layers of environmental data may be employed, the proceeding representing only a sample.

View-shed dimension—The physical dimensions of each view-shed, including; area (a), volume (v), relative depth (Δh), and/or extent (d) are calculated and attributed to each sample point (1). In this example, fields are added to the attribute database and populated with respective dimensions.

Land cover—‘Land cover’ and/or ‘land use’ types within each view-shed are summarised and attributed to each sample point. Land cover data is commonly available with detailed nomenclatures broadly categorised as: Artificial surfaces, Agricultural areas, Forests and semi-natural areas, Wetlands or Water bodies. Certain land cover classes are of particular benefit, enabling for example the identification of notably scenic crops (e.g. vine, olive, rape, sunflowers) or forestry types (e.g. deciduous, native, rainforest), or the existence of water bodies, glaciers, permanent snow, or sea cliffs. In an example, two fields may be added in order to represent land cover, the first indicating the predominant type of land cover visible, and second a value representing the relative attractiveness of that cover.

Population—Regional population density data is used in combination with land cover data to further distinguish between rural and urban regions. Population density data is typically divided into a number of classes, with values appropriately attributed to each sample point (1). In an example, two fields may be added to the attribute database in order to represent population, the first broadly categorising the area as low medium or high density, and a second a value representing the relative attractiveness of that density.

Recommended views—Data pertaining to recommended or protected views is captured. Such data is typically available as two feature types; either the object of the view (e.g. the Grand Canyon) typically represented as a polygon, or the viewing site, typically represented as a point. In an example, two fields may be added to the attribute database in order to represent recommended views, the first indicating whether the survey area contains a recommended view, and a second a value representing the relative attractiveness of that view.

Recommended routes—Established tourist routes are strong indicators of scenic content and offer a valuable insight (e.g. Route 66). Data pertaining to such routes is typically available from national tourism agencies, and includes: tourist, themed, historic and/or cultural routes. Sample points (1) on each recommended route are typically directly attributed with such data. In an example, two fields may be added to the attribute database in order to represent recommended routes, the first indicating whether the survey point is on a recommended route, and second an index representing the relative attractiveness of that route.

Tourist features—Points of interest (POI) and similar tourist features are categorised in terms of scale, value and/or type. Individual points of interest, for example; a museum, heritage building or national monument, are individually weighted and assigned to their nearest sample point (1). In an example, two fields may be added to the attribute database in order to represent tourist features, the first indicating whether the survey point is in close proximity to a tourist feature, and second a value representing the relative attractiveness of that feature.

Affluence—Demographic data, including data relating to regional affluence or deprivation is beneficial in the comparison of routes, particularly where few other notable scenic indicators exist. Such data is typically assigned directly to the sample point (1) or near field of view (n). In an example, two fields may be added to the attribute database in order to represent affluence, the first categorising whether the survey point is within an area of above/below average affluence, and second a value representing the relative affluence of the area.

Road geometry—Winding or undulating routes represent variety and are typically valued in terms of scenic content. An index of road ‘windingness’ may be most easily computed as the ratio between the straight line distance (5) between the endpoints, against the driven distance (6). A similar calculation may be performed in the vertical, using DEM elevation data, to determine road undulation. Windingness or undulation indices are attributed to each sample point (1) through comparison with the location of two or more neighbouring points. In an example, two fields may be added to the attribute database in order to represent windingness, the first a value representing the extent of the windingness, and second a value representing the relative attractiveness of that level of windingness.

Road Classification—Road classification, and/or typical speed data is widely available and used to compare routes in terms of the opportunity afforded to drive slowly or stop with ease. For example; where two routes offer similar scenic views, it is beneficial to promote navigation on the safer of the two. Such data is typically attributed directly to all sample points (1) on each road. In an example, two fields may be added to the attribute database in order to represent the classification of the survey point, the first indicating the functional classification of the route, and second a value representing the relative attractiveness of that classification.

Conservation areas—Conservation areas, including; wildlife reserves, national parks and/or geoparks, are strong indicators of scenic value. Sample points are typically attributed relative to whether the sample point is within the park and/or the amount of park visible from each point. In an example, two fields may be added to the attribute database in order to represent the conservation status of the survey point, the first indicating the percentage of the view within a conservation area, and second a value representing the relative attractiveness of that conservation area.

Genealogical areas—An important aspect to touring in some countries is genealogical research; tourists wish to tour their place of familial origin. In one embodiment the invention provides for a mechanism by which predominant family names are attributed to sample points (1) within individual localities; facilitated for example through geocoding a phonebook or genealogical mapping, therefore enabling navigation preferences of this type. In an example, one field may be added to the attribute database in order to store the dominant family surname within the view-shed.

Social network data—In one embodiment the invention consumes crowd-sourced data identifying locations of scenic value. Through examination of social network data feeds, for example geo-tweets, popular locations may be geographically referenced permitting the development of an environmental layer identifying sites or regions of popular scenic interest. In an example, one field may be added to the attribute database in order to represent the popularity of the locality of the survey point, typically indicating the number of ‘likes’ at or near that location.

Temporal scenic features—Scenery may be temporal in nature, for example; trees turn colour in fall, the aurora borealis may be visible at certain latitudes during periods of sunspot activity, or particular vegetation may be in flower during certain months. Similar short term features include the distinction between day/night views, or irregularly occurring views such as; sunsets, spectacular ocean waves, or a full moon. Where temporal factors exist, characteristics are recorded alongside each feature attribute where they may be selectively accessed by a navigation application. In an example, four fields may be added to the attribute database in order to represent temporal scenery at the survey point, the first a text field indicating the explicit description of the feature (e.g. Heather in bloom), second a classification field indicating the type of feature (e.g. natural beauty), third a value representing the relative extent and attractiveness of that feature, and fourth the expected date/time range of occurrence.

Advanced temporal searches—In one embodiment the method provides for the recording of view-shed boundary extents within the attribute database (for example as gml or kml), permitting the application to dynamically process attribute data and augment the route prediction in real time. In an example; shipping navigation feed data (AIS) may be consumed in order to promote visualisation of passing tall ships, or a news feed may be consumed in order to promote visualisation of a firework display.

Solar and lunar position. In one embodiment a celestial calendar may be employed in order to dynamically assess solar and lunar position relative to each route. Accordingly, predicted solar/lunar positions may be recorded as attributes within the attribute database table where they maybe accessed by the navigation application.

Risk—In another embodiment risk data may be assigned to each sample point. This may be permanent in nature, such as; risk associated with landslide or crime, or temporal; such as risk associated with avalanche or storm. Similarly, risk data is appropriately assigned to sample points. In an example of permanent risk (such as crime), two fields may be added to the attribute database, the first categorising the type of risk within the area of the survey point, and the second an index identifying the relative scale of that risk.

Sample point attribution may be performed in any order, using any attribute, or a plurality of attributes, and may be performed using a number of spatial union techniques.

Step D. Processing of Attribute Data

The previous step offers an attribute database table (4), or similar storage mechanism, with each row typically representing one sample point (1), and each field/column typically describing or quantifying environmental features visible from the sample point (1), though data may be stored in a variety of ways.

An algorithm is now created in order to produce a ‘scenic index’ value for each sample point (1). The creation of the algorithm, selection and weighting of variables, and subsequent computation of a scenic index is greatly subject to individual preference and may be achieved through several common mathematical methods. In one practical example, the engineer may for each survey point; a) rate the point's attractiveness within each environmental layer b) weight each environmental layer subject to preference c) determine the average attractiveness of the point across all layers relative.

Attributes typically weighted heavily include: view-shed volume (v), land-cover, and/or recommended routes or views. Said index is typically a quantitve numeric value, for example a number between 1 and 100, which may be easily employed within a navigation application.

Step E Aggregation of Survey Point Data

Attribute data representing each individual sample point may optionally be aggregated (summarised) to road level in order to provide the ‘average scenic index’ value for each individual road, rendering it more suitable for a navigation application (wherein ‘road’ may typically be understood to mean a length of roadway between two intersections).

In another optional embodiment survey points may be aggregated for the creation of ‘clouds’ which may be overlayed above (or below) map content in order to draw the users attention to the general theme of an area. In an example, clouds may highlight areas which are predominately characterised by their appeal to tourists: ‘wine region’, ‘beautiful views’, ‘business district’, ‘nightlife’ historic area'.

The invention is not limited to the embodiments described but may be varied in construction and detail.

In particular, it has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for the identification of scenic routes comprising the steps of:
a) Identifying sample locations along a road network model; and
b) Attributing said sample locations with at least one value.

2. The method of claim 1, further comprising use of a digital elevation model in order to determine inter-visibility.

3. The method of any one of the preceding claims, further comprising creating survey areas associated with each sample location.

4. The method of any one of the preceding claims, further comprising performing a view-shed calculation in order to establish a region of inter-visibility.

5. The method of any one of the preceding claims, further comprising the step of testing view-shed correctness through measurement of sky view factor.

6. The method of any one of the preceding claims, further comprising a method for testing view-shed correctness through comparison with terrestrial imagery.

7. The method of any one of the preceding claims, further comprising the splitting of the view-shed area radially, concentrically or otherwise.

8. The method of any one of the preceding claims, further comprising the calculation of view-shed dimensions.

9. The method of any one of the preceding claims, further comprising the spatial intersection of environmental data within a survey area.

10. The method of any one of the preceding claims, further comprising the computation of land cover class within a survey area.

11. The method of any one of the preceding claims, further comprising the computation of population density within a survey area.

12. The method of any one of the preceding claims, further comprising the computation of heritage buildings or villages within a survey area.

13. The method of any one of the preceding claims, further comprising the computation of deprivation or affluence within a survey area.

14. The method of any one of the preceding claims, further comprising the computation of route windingness.

15. The method of any one of the preceding claims, further comprising the computation of route undulation.

16. The method of any one of the preceding claims, further comprising the computation of conservation parklands within a survey area.

17. The method of any one of the preceding claims, further comprising the computation of areas of genealogical interest within a survey area.

18. The method of any one of the preceding claims, further comprising the identification of features subject to temporal scenic state.

19. The method of any one of the preceding claims, further comprising the storage of a survey area boundary as an attribute.

20. The method of any one of the preceding claims, further comprising the computation of a scenic value attribute through mining input from social networks.

21. The method of any one of the preceding claims, further comprising the computation of an attribute highlighting potential risk.

22. The method of any one of the preceding claims, comprising the computation of scenic index using view-shed dimensions.

23. The method of any one of the preceding claims, further comprising the compilation of attribute data for individual sample points.

24. The method of any one of the preceding claims, further comprising the weighting of attribute values.

25. The method of any one of the preceding claims, further comprising the computation of a scenic index using at least one attribute value.

26. The method of any one of the preceding claims, further comprising the aggregation of attribute data to road level.

27. The method of any one of the preceding claims, further comprising the use of a navigation application.

28. The method of any one of the preceding claims, characterised in the creation of a tour of indefinite duration.

29. The method of any one of the preceding claims, characterised in the creation of a tour of defined deviation.

30. The method of any one of the preceding claims, characterised in the creation of a ‘cloud’ representing the character or theme of a region.

31. The method of any one of the preceding claims, further comprising the identification of the ultimate coastal route as a navigation attribuite.

32. The method of any one of the preceding claims, further comprising the computation of lunar or solar positions.

33. The method of any one of the preceding claims, further comprising the substep of testing view-shed correctness comprising measurement of sky view factor.

34. The method of any one of the preceding claims, further comprising the substep of estimating route windingness and/or undulation comprising the ratio of the straight line distance between points and the surface distance between points.

35. The method of any one of the preceding claims, further comprising the substep of creation of clouds.

36. The method of any one of the preceding claims, further comprising the substep of performance of view-shed calculations along the route.

37. A method of identifying scenic routes comprising the steps of:
a) Identifying sample locations;
b) Identifying survey areas;
c) Overlaying environmental data; and
d) Processing attribute data.

38. A system for navigation, comprising:
an input device;
a data processing device; and
an output device;
wherein the input device is configured to receive identification data for identifying sample locations;
wherein the processing device is configured to attribute the identified sample locations with at least one value; and to identify the sample points along a network model; and to calculate a scenic route, and to generate image data of the scenic route;
wherein the output device is a display configured to display the image data of the scenic route.

39. A system for navigation, comprising:
an input device;
a data processing device; and
an output device;
wherein the input device is configured to receive first identification data for identifying sample locations, and second identification data for identifying survey areas;
wherein the processing device is configured to overlay environmental data and to process attribute data; and to calculate a scenic route and to generate image data of the scenic route;
wherein the output device is a display configured to display the image data of the scenic route.

40. A vehicle comprising a system for navigation according to one of the preceding claim 38 or 39.
